(19) United States
(12) Patent Application Publication
(10) Pub. No.: US 2007/0245314 A1
(43) Pub. Date: Oct. 18, 2007

(54) METHOD, SYSTEM AND COMPUTER PROGRAM FOR COLLECTING INVENTORY INFORMATION THROUGH A DATA MOVER

(76) Inventors: Francesco Maria Carteri, Roma (IT); Alessandro Donatelli, Rome (IT); Alberto Giammaria, Austin, TX (US); Luigi Pichetti, Rome (IT); Jonathan Mark Wagner, Round Rock, TX (US)

Correspondence Address: IBM CORPORATION;INTELLECTUAL PROPERTY LAW, 11400 BURNET ROAD, AUSTIN, TX, 78758, US

(21) Appl. No.: 11/677,702

(22) Filed: Feb. 22, 2007

(30) Foreign Application Priority Data
Feb. 22, 2006 (EP) 06110260.4

(51) Int. Cl. G06F 9/44

(52) U.S. Cl. 717/124; 717/127

(57) ABSTRACT

A solution (200) for collecting inventory information relating to complex resources is proposed. For this purpose, a data mover (285) interfaces with a common collector engine (210). The data mover registers (A3) itself as a listener for a selected resource class on behalf of every exploiter (265). The collector engine solves (A4) the correlations involving the selected resource class, as indicated in predefined discovery directories (235). Providers (225) adapted to discover inventory information about the correlated resource classes are periodically invoked (A5-A9), according to a scheduling plan defined in the same discovery directives. As soon as the providers for all the correlated resource classes have completed the discovery of the corresponding information (A10), the data mover is notified accordingly (A11). In response thereto, the data mover transfers (A13-A15) the discovered (delta) inventory information to the exploiter.

### FIELD OF THE INVENTION

The present invention relates to the information technology field. More specifically, the invention relates to the collection of inventory information in a data processing system.

### BACKGROUND ART

Management of different types of (physical or logical) resources, such as software programs and hardware devices, is a critical issue in a data processing system (especially with distributed architecture). This problem is particular acute when the resources are very complex and dispersed across a large number of installations; moreover, the problem is further exacerbated in a dynamic environment, wherein the resources change continually.

Resource management applications have been proposed to assist a system administrator in the above-mentioned task. Particularly, resource management applications based on the autonomic paradigm provide a mechanism that allows the system to self-adapt to a desired configuration (defined by rules published by the administrator); for example, this kind of resource management applications is described in WO-A-2004/017201.

However, any resource management application requires a detailed knowledge of the system to be controlled. For this purpose, inventory tools are exploited to collect information about selected resources in the system; an example of commercial inventory tool available on the market is the “IBM Tivoli Common Inventory Technology or CIT” component included in several solutions offered by IBM Corporation, like the “IBM Tivoli Configuration Manager or ITCM” or the “IBM Tivoli License Manager or ITLM”.

The inventory tools known in the art are generally based on a server-centric approach, wherein the whole execution flow is controlled by a central server of the system. First of all, it is necessary to define a workflow including a series of operations to be executed on multiple endpoints to discover the required information. Those discovery operations are then scheduled for their execution on the endpoints (for example, periodically). Whenever a discovery operation is submitted, the server enforces its execution on the desired endpoints. In response thereto, the endpoints discover the required information and return it to the server. The server can then process the received information according to contingent needs.

However, the above-described solution is not completely satisfactory. Particularly, a problem is experienced whenever complex resources must be discovered. Indeed, in this case the server must sequence a series of discovery operations on the relevant endpoints; for example, the discovery of a relationship between two different resources may be performed only once the discoveries of those resources have been completed. This involves the definition of a corresponding intricate workflow on the server; moreover, the repeated transmissions of requests to and information from the endpoints have a detrimental impact on the efficiency of the system.

Another drawback occurs when the type of resources to be discovered changes over time; for example, the server may be interest in discovering installed software products initially and supported services as well later on. This requires a substantial redefinition of the workflow implemented by the server, with potential side-effects on other discovery operations.

In addition, the scheduling of the discovery operations on the server is often unsatisfactory. Particularly, some discovery operations may be executed even when they are not necessary; for example, this happens when the resources involved by the discovery operations on the relevant endpoints have not changed since their last executions. Conversely, the execution rates of different discovery operations may be too low in specific situations. A typical scenario is when a software product is installed onto an endpoint without critical security patches; this causes a severe exposure of the system until the next execution of the discovery operation relating to the software product.

### SUMMARY OF THE INVENTION

The present invention provides a solution as set out in the independent claims. Advantageous embodiments of the invention are described in the dependent claims.

Particularly, an aspect of the invention proposes a method for collecting inventory information in a data processing system. For this purpose, a control structure (such as a model and/or discovery directives) is provided. The control structure defines categories of system resources (for example, classes) and correlations among the categories; each category is associated with a provider for discovering inventory information relating to the resources of the category (for example, its instances). The method involves the step of receiving a discovery request for a selected category (or more) from an exploiter entity (such as a remote resource manager). The categories correlated with the selected category in the control structure are then determined. The method continues discovering correlated inventory information (relating to the resources of the correlated categories that are available in the system) through correlated providers associated with the correlated categories in the control structure. At the end, the correlated inventory information is transferred to the exploiter entity.

In an embodiment of the invention, this result is achieved by registering a data mover as a listener (for the selected category) with a common collector engine.

Preferably, one or more of the providers have an internal cache for storing the corresponding inventory information that is discovered.

Without detracting from its general applicability, the invocation of the providers is scheduled according to corresponding time policies defined in the discovery directives.

As a further improvement, some providers may be invoked in response to the occurrence of asynchronous events.

In a preferred embodiment of the invention, each provider only returns the changes that have occurred since a preceding iteration of the process.

A way to further improve the solution is of defining policies (in the discovery directives) for controlling the transfer of the discovered information.

For example, it is possible to prevent the transfer until the discovered information reaches a minimum size.

Another aspect of the invention proposes a computer program for performing the method.

A further aspect of the invention proposes a corresponding system.

### REFERENCE TO THE DRAWINGS

The invention itself, as well as further features and the advantages thereof, will be best understood with reference to the following detailed description, given purely by way of a non-restrictive indication, to be read in conjunction with the accompanying drawings, in which:

FIG. 1a is a schematic block diagram of a data processing system in which the solution according to an embodiment of the invention is applicable;

FIG. 1b shows the functional blocks of an exemplary computer of the system;

FIG. 2 is a collaboration diagram representing the roles of different components implementing the solution according to an embodiment of the invention; and

FIGS. 3a-3b show a sequence diagram describing interactions among different components in an exemplary application of the solution according to an embodiment of the invention.

### DETAILED DESCRIPTION

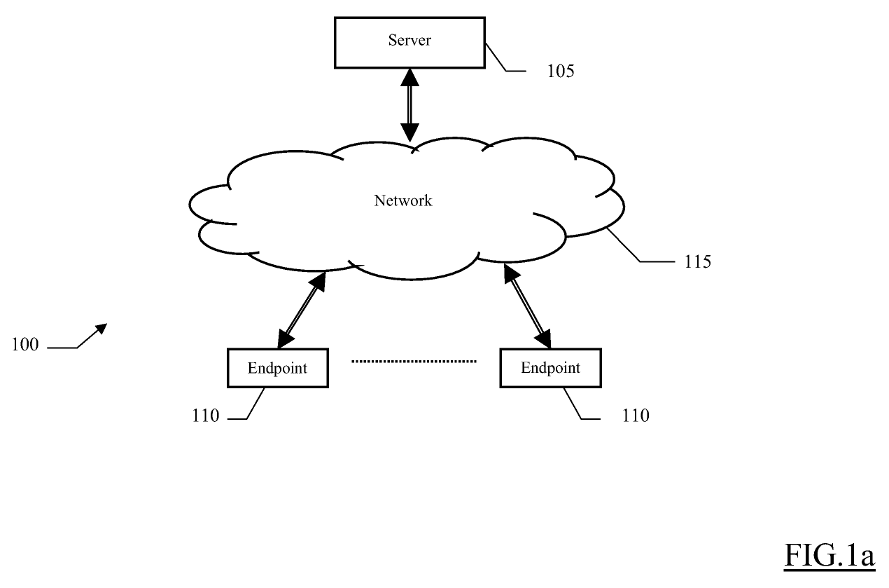

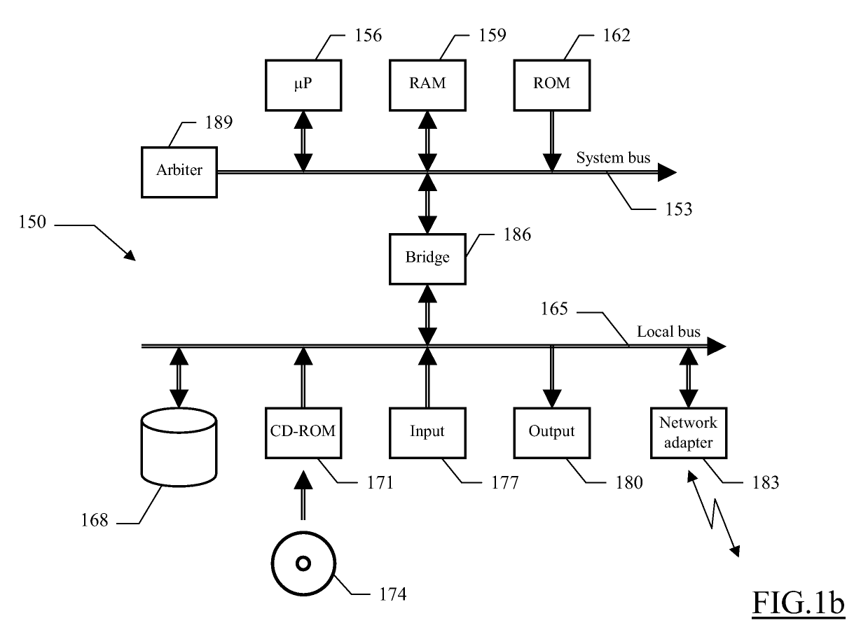

With reference in particular to FIG. 1a, a data processing system 100 with distributed architecture is illustrated. The system 100 implements an infrastructure for managing a number of physical or logical resources. Examples of those resources are computers, mobile telephones, hardware devices, software programs, network components, Internet addresses, storage subsystems, users, roles, organizations, databases, messaging queues, application servers, services, business activities, and the like.

Particularly, a central server 105 is responsible to define the configuration of the system 100. Multiple endpoints 110 directly control one or more resources to be managed. The server 105 and the endpoints 110 are coupled through a network 115 (typically Internet-based).

For example, the system 100 implements a software distribution infrastructure. In this case, the server 105 collects information about a current configuration of each endpoint 110; this information is used to plan the enforcement of selected software packages, which are used to reach a desired software configuration of the endpoints 110 (as defined in a reference model). An example of commercial software application available on the market for this purpose is the above-mentioned “ITCM”.

Considering now FIG. 1b, a generic computer of the above-described system (server or endpoint) is denoted with 150. The computer 150 is formed by several units that are connected in parallel to a system bus 153 (with a structure that is suitably scaled according to the actual function of the computer 150 in the system). In detail, one or more microprocessors (μP) 156 control operation of the computer 150; a RAM 159 is directly used as a working memory by the microprocessors 156, and a ROM 162 stores basic code for a bootstrap of the computer 150. Several peripheral units are clustered around a local bus 165 (by means of respective interfaces). Particularly, a mass storage consists of one or more hard-disks 168 and a drive 171 for reading CD-ROMs 174. Moreover, the computer 150 includes input units 177 (for example, a keyboard and a mouse), and output units 180 (for example, a monitor and a printer). An adapter 183 is used to connect the computer 150 to the network. A bridge unit 186 interfaces the system bus 153 with the local bus 165. Each microprocessor 156 and the bridge unit 186 can operate as master agents requesting an access to the system bus 153 for transmitting information. An arbiter 189 manages the granting of the access with mutual exclusion to the system bus 153.

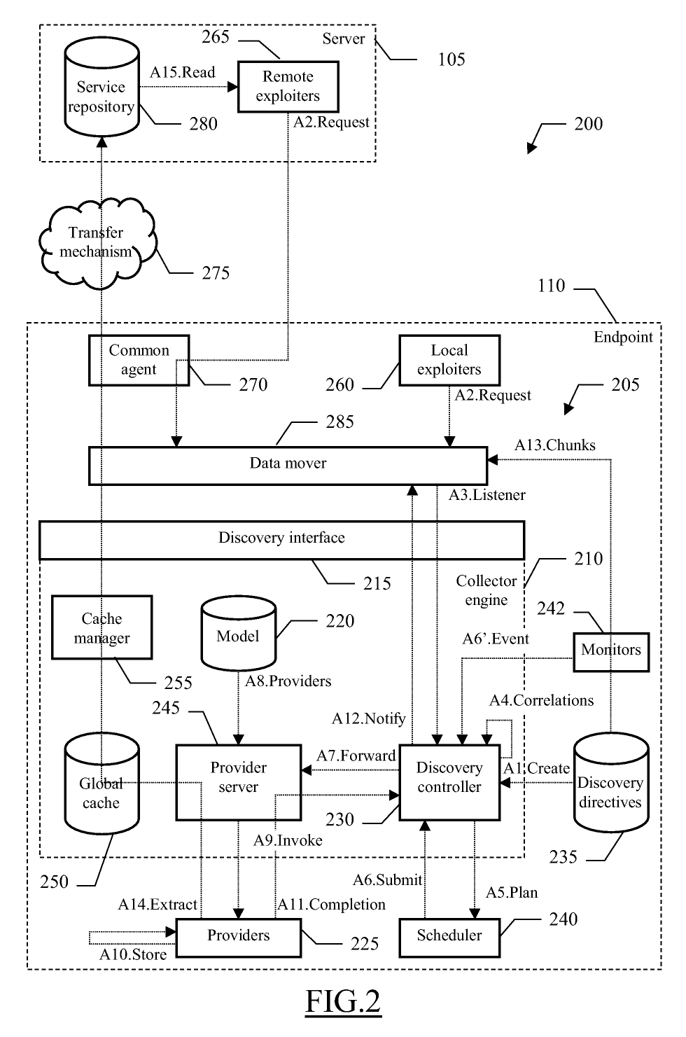

Moving to FIG. 2, the main software components that run on the above-described system are denoted as a whole with the reference 200. The information (programs and data) is typically stored on the hard-disk and loaded (at least partially) into the working memory of each computer when the programs are running. The programs are initially installed onto the hard disk, for example, from CD-ROM. Particularly, the figure describes the static structure of the system (by means of the corresponding components) and its dynamic behavior (by means of a series of exchanged messages).

Considering a generic endpoint 110, an inventory framework 205 implements a service for collecting inventory information about the resources controlled by the endpoint 110 (for example, based on the above-mentioned CIT). The main module of the inventory framework 205 is a common collector engine (CCE) 210, which provides a single access point for discovering the required inventory information. For this purpose, the collector engine 210 exposes a discovery interface 215 (with a set of predefined APIs allowing discovering any inventory information in a unified manner).

The collector engine 210 stores a model 220, which defines each category of resources under management, possibly available in the system, by a corresponding class in the object-oriented paradigm (for example, written in the “Unified Information Model or UIM” language). The different resource classes are associated with corresponding providers 225 (external to the collector engine 210). The providers 225 are plug-in components, which encapsulate the knowledge of the associated resource categories. In this way, the different behavior of the myriad of resources to be discovered is completely masked to the collector engine 210; moreover, the inventory framework 205 may be easily extended by adding new providers 225 for corresponding resource categories.

More specifically, each provider 225 discovers the inventory information about the resources available and converts it into corresponding instances of the resource class (each one representing an actual resource). For this purpose, the provider 225 typically performs hardware or software scanning operations, inspect catalogues, registries, and the like; the provider 225 may also discover resource instances on remote computers, by delegating the operation to secondary modules installed thereon. In more complex situations, the provider 225 is adapted to infer the inventory information from available observations (such as calculated statistics, registered transactions, measured network flows, and the like). For example, the provider 225 may be based on a hardware scanner (capable to determine the physical configuration of the endpoint 110 by reading a corresponding hardware register), or on a software scanner (capable to determine the software products installed on the endpoint 110 by scanning its file system and comparing any executable module with predefined signatures available in a software catalogue).

Every provider 225 implements a method that enumerates all the resource instances that are discovered for the corresponding resource class (possibly filtered according to selected criteria). The provider 225 may be of the interactive type, wherein it generates the resource instances dynamically upon request. This ensures that the inventory information is always up-to-date; the interactive providers 225 are well suited to resources that are fast to discover (for example, hardware features) or volatile (for example, logged users). Conversely, a provider 225 of the cached type has an internal cache that is used to store the resource instances that had been discovered in advance. Therefore, when the provider 225 is queried it returns the inventory information immediately. As a result, the response time of the provider 225 is very low; the cached providers 225 are typically used for resources that are difficult to discover (for example, installed software products) or with a slow dynamic (for example, hardware configurations). The providers 225 of the cached type implement additional methods; particularly, a method is used to prepare or refresh the information in the internal cache (for example, periodically), and another method is used to invalidate the same information (for example, when its age reaches a maximum allowable value). The provider 225 may also be of the indication type; in this case, the provider 225 will issue a notification (to registered listeners) for any change that is discovered in the corresponding resources. This feature allows collecting delta (inventory) information consisting of the changes that have occurred since a last discovery operation; particularly, it is possible to have the provider 225 enumerate the changed resource instances only (i.e., the ones that have been created, updated or deleted). Optionally, a provider 225 of the batch type also stores all the above-mentioned events; this allows collecting delta information relating to whatever period.

The automated discovery of the inventory information is controlled by a module 230 according to corresponding directives 235 (defined by a system administrator through the discovery interface 215).

Each discovery directive 235 relates to a specific resource class (“What” parameter). The discovery directive 235 specifies a time policy for discovering the corresponding resource instances (“When” parameter); for example, it is possible to indicate that the discovery operation must be performed periodically, such as every 2-6 hours (thereby defining the refresh rate of the internal cache of the corresponding provider 225 when of the cached type). Optionally, the discovery directive 235 delimits a specific area of interest (“Where” parameter); for example, the discovery operation may be restricted to a subset of network addresses. The discovery directive 235 may also specify additional information about the execution of the discovery operation (“How” parameter); for example, it is possible to indicate that the discovered inventory information must be processed only when it reaches a predefined minimum size (defining a basic transmission chunk).

Other discovery directives 235 relate to classes, which model correlations among multiple resource categories. For example, a resource class may be contained within another one (such as the resource class for storage devices and the resource class for computers, respectively); in this case, the discovery of the computer class must precede the one of the storage device class (since the latter cannot exist without the former). Moreover, a resource class may specialize another one (such as the resource classes for operating systems and application programs and the resource class for generic software products, respectively); in this case, the discovery of the software product class involves the discovery of the operating system class and of the application program class. As another example, a correlation links a resource class with another one that depends on its changes (such as the resource class for hardware and the resource class for software, respectively); in this case, whenever any change is discovered for the hardware class, the software class should be checked as well (since a change is very likely to have occurred as well). Moreover, a resource class may use other ones (such as the resource class for software recognition and the resource classes for signatures, file system and registry, respectively); in this case, the discovery of the software recognition class consists of the discovery of the signature class, of the file system class and of the registry class.

The discovery controller 230 determines the discovery operations to be performed and generates a plan for their execution in the right order (according to the discovery directives 235). The plan so obtained is passed to a scheduler 240 (external to the collector engine 210). The scheduler 240 controls the submission of the plan, which involves the running of a job for each discovery operation; the job in turn invokes the execution of the corresponding discovery operation by the discovery controller 230. In this way, it is possible to change the scheduler 240 without any impact on the collector engine 210. Optionally, the endpoint 110 may also include one or more external monitors 242, which can fire selected events (such as relating to asynchronous hardware and/or software changes on the endpoint 110); for example, a monitor 242 may detect when a new hardware component is added, when a new software product is installed, and the like. In this case, the monitor 242 notifies the discovery controller 230 accordingly so as to cause the execution of discovery operation(s) for the resource classes impacted by the event.

In any case, the discovery controller 230 forwards a corresponding request to a provider server 245, which controls the actual execution of the required discovery operations. For this purpose, the provider server 245 accesses the model 220 (to determine the providers 225 associated with the resource classes involved by the discovery operations). For each discovery operation to be executed, the provider server 245 invokes the relevant provider 225.

Optionally, the collector engine 210 also includes a global cache 250. A module 255 manages the information stored in the global cache 250; particularly, the cache manager 255 extracts the desired information from the global cache 250, invalidates it when necessary, and the like. This allows providing functionality typical of the cached provides 225 (such as the possibility of discovering delta information or the handling of the inventory information in transmission chunks) even for interactive providers 225.

The services of the collector engine 210 are accessed by multiple exploiters 260,265 (for example, a resource manager such as the “Change Manager or CM” service of the “ITCM” in the example at issue). Particularly, local exploiters 260 run on the same endpoint 110. On the other hand, remote exploiters 265 running on the server 105 access the services of the collector engine 210 through a common agent 270; the common agent 270 provides a single run-time environment, which wraps a bundle of multiple services (for example, defined according to the “Service Management Framework or SMF” implementing a compliant version of the “Open Service Gateway initiative or OSGi” standard by IBM Corporation). For this purpose, a transfer mechanism 275 is used to communicate between the endpoint 110 and the server 105; preferably, the transport mechanism 275 exposes a standard interface independent of the underlying protocol that is actually used (such as the TCP/IP, the FTP, the HTTP, and the like). The transfer mechanism 275 stores the required inventory information on the server 105 into a service repository 280, which is accessed by the remote exploiters 265.

As described in detail in the following, in the solution according to an embodiment of the invention the (local or remote) exploiters 260,265 interact with the collector engine 210 through a data mover 285. Particularly, the data mover 285 receives discovery requests from the exploiters 260,265 for inventory information about selected resource classes. For each discovery request, the data mover 285 registers itself with the collector engine 210 as a consumer for the inventory information relating to the corresponding selected resource class. The collector engine 210 (through the appropriate providers 225) discovers the resource instances for the resource classes correlated with the selected one, as indicated in the discovery directives 235. As soon as the process has been completed for all the above-mentioned correlated resource classes, the data mover 285 returns the desired inventory information to the exploiters 260,265.

In this way, the exploiters 260,265 are completely de-coupled from the correlations existing among the resources to be discovered. As a result, the corresponding workflow on the server 105 is strongly simplified; moreover, this reduces the amount of information to be transmitted on the network, with a beneficial impact on the efficiency of the whole system.

The proposed solution is very flexible, since it allows changing the resource classes to be discovered in a very simple manner (without substantially redefining the workflow on the server). For example, let us assume that the exploiters 260,265 are at first interested in collecting inventory information about software products installed on the endpoint 110 and then on services provided by it as well; in this case, the administrator will simply add the above-mentioned correlation to the discovery directives 235, so as to have the desired inventory information collected automatically in a way that is completely opaque to the exploiters 260,265.

More specifically, the discovery directives 235 are at first created by the administrator (action A1). A generic exploiter 260,265 submits a request to the data mover 285 for inventory information about a selected resource category defined by its resource class (action A2). In response thereto, the data mover 285 registers itself with the discovery controller 230 (through the discovery interface 215) as a listener on events relating to the selected resource class (action A3). As a result, the discovery controller 230 solves the correlations involving the selected resource class (as indicated in the discovery directories 235); in this way, the discovery controller 230 determines the resource classes correlated with the selected one (either including or not the selected resource class itself), which should be taken into account to complete the whole discovery operation (action A4). The discovery controller 230 defines the corresponding plan, which includes the execution (according to the discovery directives 235) of a discovery operation for each correlated resource class; the plan so obtained is then passed to the scheduler 240 (action A5).

The scheduler 240 submits this plan; each job of the plan (when run) invokes the execution of the corresponding discovery operation by the discovery controller 230 (action A6). The same point is also reached whenever a generic monitor 242 fires an event requiring the execution of one or more discovery operations (action A6′). The discovery controller 230 forwards each request to the provider server 245 (action A7). The provider server 245 (according to the model 220) determines the provider 225 associated with the resource class specified in the request (action A8). This provider 225 is then invoked by the server provider 245 (action A9). Assuming that the provider 225 is of the cached type, it stores the discovered resource instances (if any) into the corresponding local cache (action A10). The provider 225 then notifies an event indicating the completion of the discovery operation through the provider server 245 to the discovery controller 230 (action A11).

In this way, the discovery of the inventory information (by the provider 225) is completely independent of its consumption (by the exploiters 260,265). Particularly, each exploiter 260,265 will simply submit the discovery request for the desired inventory information without specifying how it is discovered; this aspect is instead completely delegated to the discovery directives 235. Therefore, any change in the time policy for scheduling the discovery operations is totally opaque to the exploiter 260,265. As a further improvement, the monitor 242 also allows responding to asynchronous events immediately. For example, the provider 225 associated with a resource class for hardware can be triggered as soon as a new component is plugged into the endpoint 110 (so as to discover the new resource instance representing this component); likewise, the provider associated with a resource class for software can be triggered as soon the installation of a new software product on the endpoint 110 is detected (so as to discover the new resource instance representing this software product). In any case, the discovery of the inventory information can be tuned to any contingent need. For example, it is possible to avoid performing unnecessary operations when no resource has changed or to avoid discovering critical inventory information too late. It is emphasized that any update to the way in which the inventory information is discovered does not require any intervention on the workflow implemented by the server 105.

The discovery controller 230 aggregates the received completion events; as soon as the discovery operations for the providers 225 associated with all the correlated resource classes have been completed, the discovery controller 230 notifies the data mover 285 accordingly through the discovery interface 215 (action A12). In response thereto, the data mover 285 preferably verifies whether the size of the whole inventory information (discovered by all the involved providers 225) reaches the transmission chunk, as indicated in the discovery directives 235 specific for the data mover 285 (action A13). If so, the data mover 285 passes the discovered inventory information to the corresponding exploiter 260,265. Considering in particular the remote exploiter 265, for this purpose the data mover 285 (flowing the received change notifications) extracts the delta information from the internal cache of each relevant provider 225 (action A14); in this way the amount of information to be transferred is strongly reduced. The delta information is then sent through the transfer mechanism 275 to the server 105, wherein it is stored into the service repository 280. The remote exploiter 265 can then read the required inventory information from the service repository 280 (action A15). As a result, a tunnel is implemented between the provider 225 and the exploiter 265; particularly, the operations required to discover the inventory information are now completely masked to the exploiter 265.

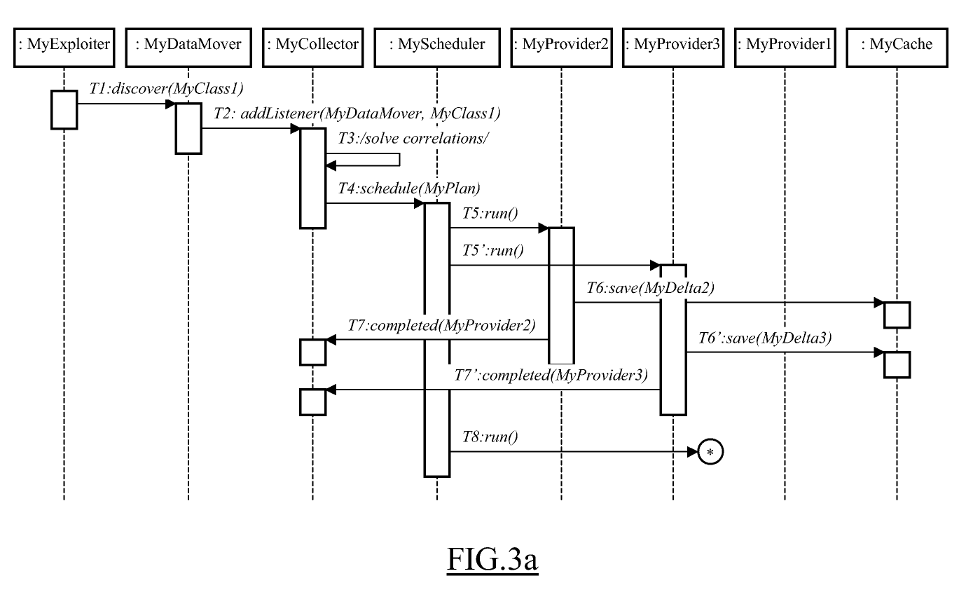

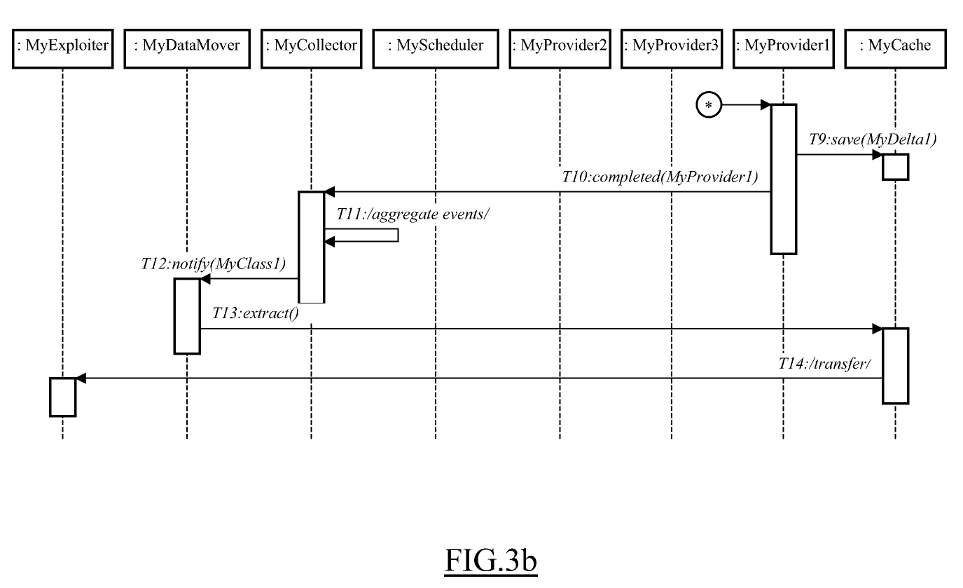

Moving now to FIGS. 3a-3b, the dynamic behavior of an exemplary application of the solution according to an embodiment of the invention is illustrated by means of a series of sequenced messages that are exchanged among the relevant components. For example, let us assume that a generic exploiter MyExploiter is interested in collecting inventory information about the resources modeled by the class MyClass1. For this purpose, the exploiter MyExploiter at the time T1 submits a discovery request to the data mover (object MyDataMover), passing the resource class MyClass1 as a parameter (message “discover(MyClass1)”). The data mover MyDataMover at the time T2 registers itself with the collector engine (object MyCollector), through the discovery interface, as a listener for the same resource class MyClass1 (message “addListener(MyDataMover, MyClass1)”).

Considering now the time T3, the collector engine MyCollector solves the correlations involving the resource class MyClass1 (action “\solve correlations\”). For example, let us assume that the administrator has created a series of discovery directives specifying that the resource class MyClass1 uses the resource classes MyClass2,MyClass3, and that the resource class MyClass2 in turn uses the resource class MyClass3. In this case, the set of correlated resource classes will consist of the resource classes MyClass1, MyClass2 and MyClass3. The process continues to the time T4, wherein the collector engine MyCollector submits the plan (object MyPlan) to the scheduler (object MyScheduler) for the execution of the discovery operations relating to those correlated resource classes MyClass1-MyClass3 (message “schedule (MyPlan)”). For example, let us assume that the discovery directives specify that the resource class MyClass1 must be discovered every week, whereas the resource classes MyClass2 and MyClass3 must be discovered every day. In this case, the plan MyPlan will include a discovery operation for the resource class MyClass1 (to be executed repeatedly, for example, every Sunday night), a discovery operation for the resource class MyClass2 and a discovery operation for the resource class MyClass3 (both of them to be executed repeatedly, for example, every night).

The scheduler MyScheduler then submits the plan MyPlan. Therefore, the jobs for the above-mentioned discovery operations are run according to their time constraints (taking into account the data processing resources available for the execution). For example, Saturday night the job corresponding to the discovery operation for the resource class MyClass2 is run at the time T5, so as to cause the collector engine MyCollector to determine the provider (object MyProvider2) associated with the resource class MyClass2 in the model and to invoke it (message “run ( )”). In this way, as soon as the discovery operation has been completed (time T6) the provider MyProvider2 saves the delta information consisting of the changed resource instances for the resource class MyClass2 (object MyDelta2) into its internal cache, generically represented by a common object MyCache for all the correlated resource classes MyClass1-MyClass3 (message “save(MyDelta2)”). As a consequence, a corresponding completion event is returned to the collector engine MyCollector at the time T7 (message “completed(MyProvider2)”). The job corresponding to the discovery operation for the resource class MyClass3 is likewise submitted later on at the time T5′, so as to cause the collector engine MyCollector to determine the associated provider (object MyProvider3) and to invoke it (message “run ( )”). In a completely independent way, as soon as the discovery operation has been completed (time T6′) the provider MyProvider3 saves the resulting delta information (object MyDelta3) into its local cache (message “save (MyDelta3)”). The corresponding completion event is then returned to the collector engine MyCollector at the time T7′ (message “completed(MyProvider3)”). Sunday night the job corresponding to the discovery operation for the resource class MyClass1 is submitted as well at the time T8, so as to cause the collector engine MyCollector to determine the associated provider (object MyProvider1) and to invoke it (message “run ( )”). As soon as the discovery operation has been completed (time T9), the provider MyProvider1 saves its delta information (object MyDelta1) into the internal cache (message “save(MyDelta1)”). The corresponding completion event is returned to the collector engine MyCollector at the time T10 (message “completed (MyProvider1)”).

Once the discovery operations for all the correlated resource classes MyClass1-MyClass3 have been completed, the collector engine MyCollector aggregates those events at the time T11 (action “aggregate events”). The collector engine MyCollector then notifies the data mover MyDataMover at the time T12 that the required inventory information for the selected resource class MyClass1 is available (message “notify(MyClass1)”). As a consequence, the data mover MyDataMover at the time T13 will start extracting the delta information MyDelta1, MyDelta2 and MyDelta3 from the corresponding internal cache MyCache (message “extract( )”). This information is then transferred to the exploiter MyExploiter at the time T14 (action “/transfer/”).

Naturally, in order to satisfy local and specific requirements, a person skilled in the art may apply to the solution described above many modifications and alterations. Particularly, although the present invention has been described with a certain degree of particularity with reference to preferred embodiment(s) thereof, it should be understood that various omissions, substitutions and changes in the form and details as well as other embodiments are possible; moreover, it is expressly intended that specific elements and/or method steps described in connection with any disclosed embodiment of the invention may be incorporated in any other embodiment as a general matter of design choice.

Particularly, similar considerations apply if the system has a different architecture or includes equivalent units. For example, the system may include a different number of clients and/or servers; however, nothing prevents the application of the proposed solution to a single computer. Moreover, each computer may have another structure or may include similar elements (such as cache memories temporarily storing the programs or parts thereof to reduce the accesses to the mass memory during execution); in any case, it is possible to replace the computer with any code execution entity (such as a PDA, a mobile phone, and the like).

Although in the preceding description reference has been made to a software distribution application, the inventory information may be collected for whatever resource management purpose (for example, for use in a license management infrastructure). Likewise, it is possible to collect inventory information of different type; moreover, the resources taken into account are merely illustrative and they must not be interpreted in a limitative manner. Similar considerations apply if equivalent models are provided for whatever categories of resources, if the discovery directives are defined in another way, or if other providers are supported (for example, each one serving two of more resource classes); moreover, the proposed technical idea may find application to discover correlations of whatever type among the resources. In any case, it is possible to exploit equivalent control structures for either the model and/or the discovery directives; for example, the correlations may be defined in the model (instead of in the discovery directives).

Without departing from the principles of the invention, the data mover and/or the collector engine may be replaced with equivalent modules.

It should be readily apparent that the proposed solution may also be applied to providers that are not of the cached type (for example, by exploiting the cache manager of the collector engine).

Moreover, a basic implementation wherein the scheduler is replaced with a simple timer service (provided with the collector engine) is not excluded.

On the other hand, the handling of the asynchronous events is not strictly necessary and it may be omitted in some embodiments of the invention.

Even though the data mover has been specifically designed for transferring delta information only, this is not to be interpreted in a limitative manner; in other words, the application of the proposed solution to a data mover that always returns the whole inventory information that was discovered is contemplated.

Similar considerations apply if the discovery directives (specific for the data mover) define other policies for controlling the transfer of the inventory information, such as according to a maximum allowable network bandwidth. Alternatively, it is possible to implement any other policy relating to the collection of the inventory information (for example, limiting the processing power to be used by the providers). In any case, an implementation that does not support any transfer policies is within the scope of the invention.

Similar considerations apply if the program (which may be used to implement each embodiment of the invention) is structured in a different way, or if additional modules or functions are provided; likewise, the memory structures may be of other types, or may be replaced with equivalent entities (not necessarily consisting of physical storage media). Moreover, the proposed solution lends itself to be implemented with an equivalent method (having similar or additional steps, even in a different order). In any case, the program may take any form suitable to be used by or in connection with any data processing system, such as external or resident software, firmware, or microcode (either in object code or in source code). Moreover, the program may be provided on any computer-usable medium; the medium can be any element suitable to contain, store, communicate, propagate, or transfer the program. Examples of such medium are fixed disks (where the program can be pre-loaded), removable disks, tapes, cards, wires, fibers, wireless connections, networks, broadcast waves, and the like; for example, the medium may be of the electronic, magnetic, optical, electromagnetic, infrared, or semiconductor type.

In any case, the solution according to the present invention lends itself to be carried out with a hardware structure (for example, integrated in a chip of semiconductor material), or with a combination of software and hardware.

1. A method for collecting inventory information in a data processing system, the method including the steps of:
providing a control structure defining categories of system resources and correlations among the categories, each category being associated with a provider for discovering inventory information relating to the resources of the category,
receiving a discovery request for at least one selected category from an exploiter entity,
determining categories correlated with the selected category in the control structure,
discovering correlated inventory information relating to the resources of the correlated categories being available in the system through correlated providers associated with the correlated categories in the control structure, and
transferring the correlated inventory information to the exploiter entity.

2. The method according to claim 1, wherein the discovery request is received by a common data mover, the method further including the steps of:
registering the data mover as a listener for the selected category with a common collector engine, the collector engine controlling the determining of the correlated categories and the discovering of the correlated inventory information, and
notifying the data mover by the collector engine in response to the discovering of the correlated inventory information for all the correlated categories, the data mover controlling the transferring of the correlated inventory information in response to said notifying.

3. The method according to claim 1, wherein each provider is coupled with a cache memory for the corresponding inventory information, for each correlated provider the step of discovering the correlated inventory information including:
invoking the correlated provider by the collector engine,
storing the correlated inventory information into the cache memory, and
signaling the completion of the discovering of the correlated inventory information to the collector engine.

4. The method according to claim 3, wherein for at least one first correlated category associated with a first correlated provider the control structure further defines a time policy for the discovering of the inventory information relating to the resources of the first correlated category, the step of discovering the correlated inventory information including:
scheduling a plan for invoking each first correlated provider according to the corresponding time policy, the first correlated provider being invoked according to the plan.

5. The method according to claim 3, wherein for at least one second correlated category associated with a second correlated provider the step of discovering the correlated inventory information includes:
monitoring the occurrence of asynchronous events for each second correlated category, the corresponding second correlated provider being invoked in response to each asynchronous event.

6. The method according to any claim 1, wherein the correlated inventory information discovered by each correlated provider is representative of a change in the resources of the associated correlated categories from a preceding discovering of the correlated inventory information.

7. The method according to claim 1, wherein for at least one third correlated category the control structure further defines a transfer policy for the corresponding correlated inventory information, the correlated inventory information being transferred to the exploiter entity according to said transfer policy.

8. The method according to claim 7, wherein the exploiter entity runs on a remote server and wherein the transfer policy specifies a minimum size of the correlated inventory information, the method further including the step of:
preventing the transfer of the correlated inventory information to the exploiter entity until the reaching of the minimum size.

9. (canceled)

10. (canceled)

11. A computer program product in a computer-usable medium, the computer program when executed on a data processing system causing the system to perform a method for collecting inventory information in the system, the method including the steps of:
providing a control structure defining categories of system resources and correlations among the categories, each category being associated with a provider for discovering inventory information relating to the resources of the category,
receiving a discovery request for at least one selected category from an exploiter entity,
determining categories correlated with the selected category in the control structure,
discovering correlated inventory information relating to the resources of the correlated categories being available in the system through correlated providers associated with the correlated categories in the control structure, and

12. A data processing system including:
a discovery interface for providing a model defining categories of system resources and correlations among the categories, each category being associated with a provider for discovering inventory information relating to the resources of the category,
a data mover for receiving a discovery request for at least one selected category from an exploiter entity,
a collector engine for determining categories correlated with the selected category in the model and for discovering correlated inventory information relating to the resources of the correlated categories being available in the system through correlated providers associated with the correlated categories in the model, and
a transfer mechanism for transferring the correlated inventory information to the exploiter entity.
